(19) United States
(12) Patent Application Publication
(10) Pub. No.: US 2018/0193109 A1
(43) Pub. Date: Jul. 12, 2018

(54) Ergonomic Dental Hand Instrument System

(71) Applicants: Peter Douglas, Newtown Square, PA (US); Moiz Hakimi, Cranbury, NJ (US)

(72) Inventors: Peter Douglas, Newtown Square, PA (US); Moiz Hakimi, Cranbury, NJ (US)

(73) Assignees: Peter Douglas, Newtown Sqaure, PA (US); Moiz Hakimi, Cranbury, NJ (US)

(21) Appl. No.: 15/861,626

(22) Filed: Jan. 3, 2018

Related U.S. Application Data
(60) Provisional application No. 62/444,287, filed on Jan. 9, 2017.

(51) Int. Cl. A61C 3/00

(52) U.S. Cl. CPC A61C 3/00; B25G 1/102

(57) ABSTRACT

A dental scaler system consisting of an ergonomically designed body and interchangeable tip assemblies designed to minimize fatigue due to prolonged strain from instrument grip and use. The device has a centrally located opening shaped to receive the index finger for a comfortable reduced strain grip. The opening is shaped such that it is possible to maneuver and rotate the device around the index finger allowing the user to change from one working end to the other in a single handed manner while continuing to hold the device. The device is designed to utilize detachable and interchangeable tips including spacers to adjust the overall length of the device or as a one piece unit with fixed instrument tips.

### BACKGROUND OF THE INVENTION

Currently, a dental hand instrument such as a dental scalar is a hollow or solid metallic and/or polymer device which requires the user to hold the device like a pen in a manner such that it can impart stress to the fingers, thumb, palm, and the wrist with repetitive or prolonged use. Design changes to reduce the pinch force needed to hold the instruments such as increasing the diameter of the instrument handles and adding soft grip materials such as silicone to the handles has made minimal difference in the rate of musculoskeletal disorder.

In performing dental procedures, the need to hold and use the instrument using pinch force increases risk for musculoskeletal disorder. Individuals who use this style of instrument are at an increased risk of experiencing hand fatigue and potential permanent damage that can lead to the inability to perform such functions.

### BRIEF SUMMARY OF THE INVENTION

The Ergonomic Dental Hand Instrument System described herein is designed to minimize finger, thumb, palm and wrist strain by adding a centrally located ring that is designed to receive the user's index finger. This design reduces the need to use pinch force to hold the instrument. The top surface of the elongated body is designed and shaped to support the index finger and is textured to increase grip and stability. The sides of the elongated body are designed and shaped to contact the thumb and middle finger for handling the instrument.

The proximal and distal ends of the handle are designed to accept interchangeable tip assemblies consisting of a collar and instrument tip. The tip assemblies can be attached in multiple radial positions of the users choosing.

The instrument is designed for single handed use. It can be rotated around the index finger allowing the user to change working ends of the instrument without removing the instrument from the index finger.

### BRIEF DESCRIPTION OF THE DRAWINGS

FIG. 1: Scaler Assembly System

FIG. 2: Scaler Assembly System shown fully assembled

FIG. 3: Scaler Assembly System shown with Interchangeable Tip Assemblies detached from Body

FIG. 4: Scaler Body

FIG. 5: Scaler Body side view

FIG. 6: Scaler Body top view

FIG. 7: Scaler Body cross sectional view

FIG. 8: Scaler Body cross sectional view blow up

FIG. 9: Scaler Tip Assembly

FIG. 10: Scaler Tip Assembly side view

FIG. 11: Scaler Tip Assembly cross sectional view

FIG. 12: Scaler tip

FIG. 13: Attachment Collar

FIG. 14: Attachment Collar cross sectional view

FIG. 15: One Piece integrated scaler (non-interchangeable tips)

FIG. 16: One Piece integrated scaler (non-interchangeable tips) side view

FIG. 17: Scaler assembly with spacers

FIG. 18: Spacer

FIG. 19: Spacer side view

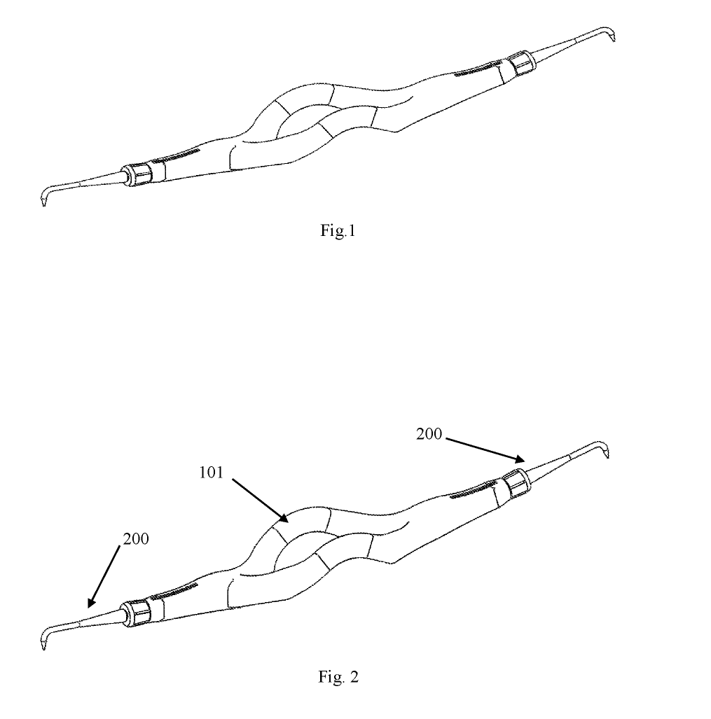

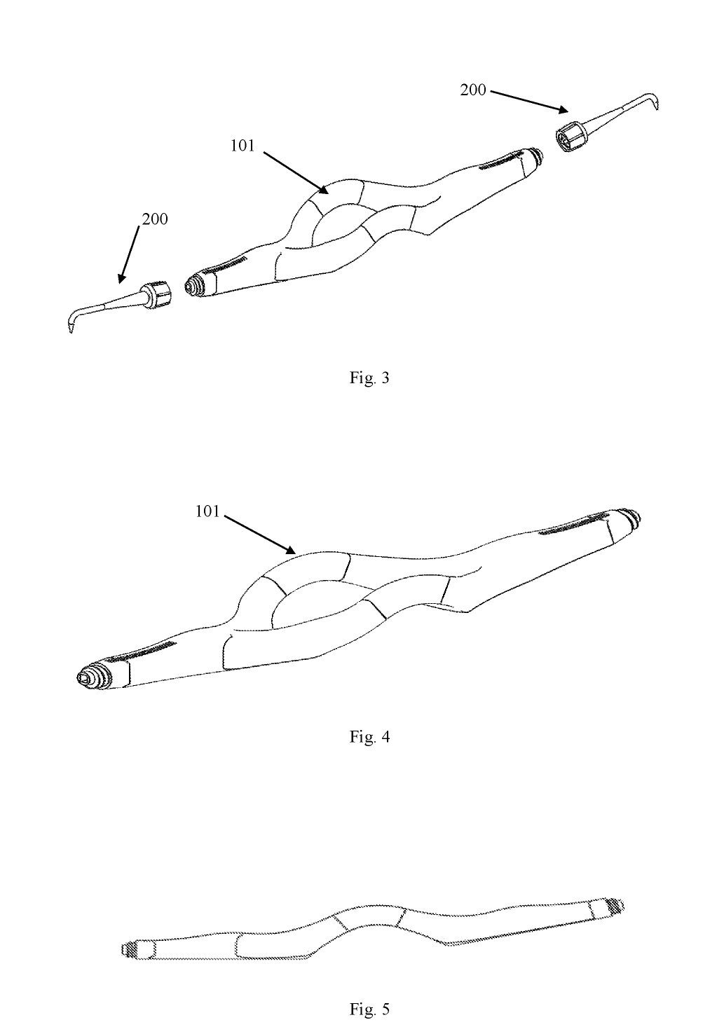

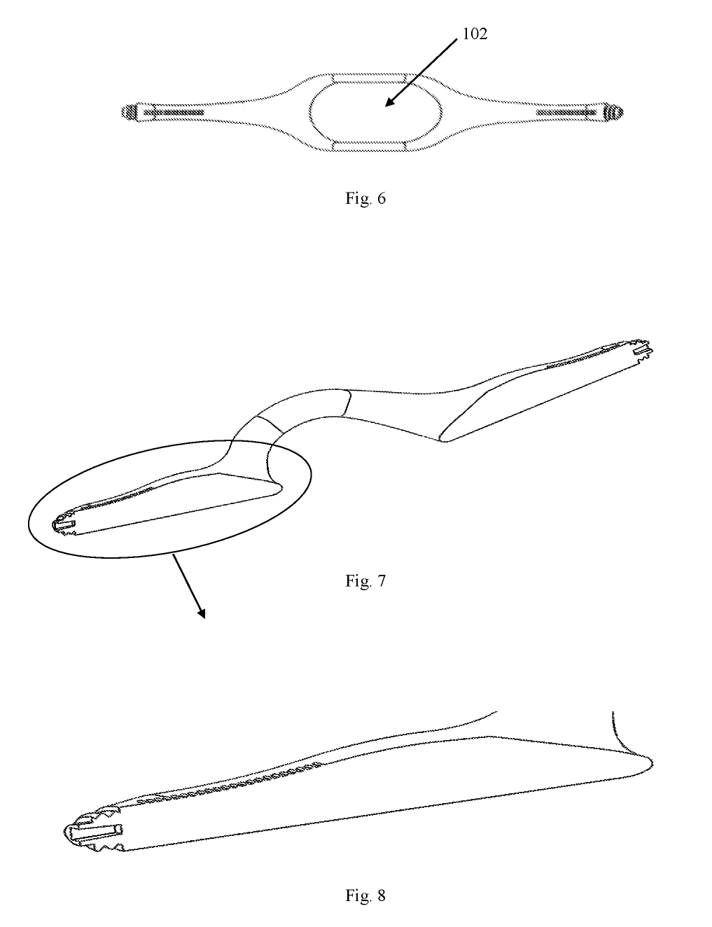

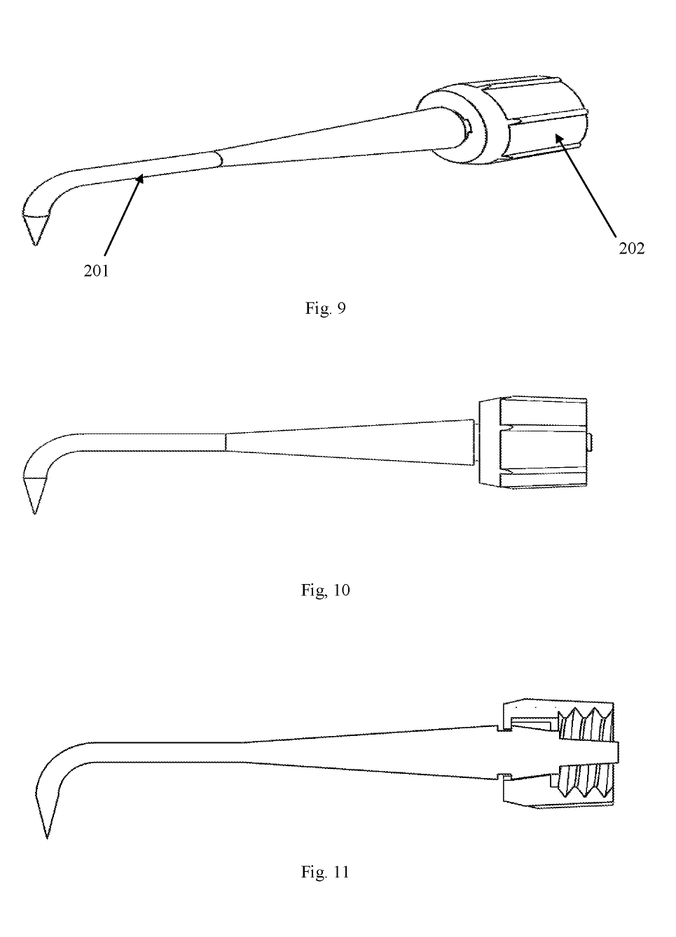

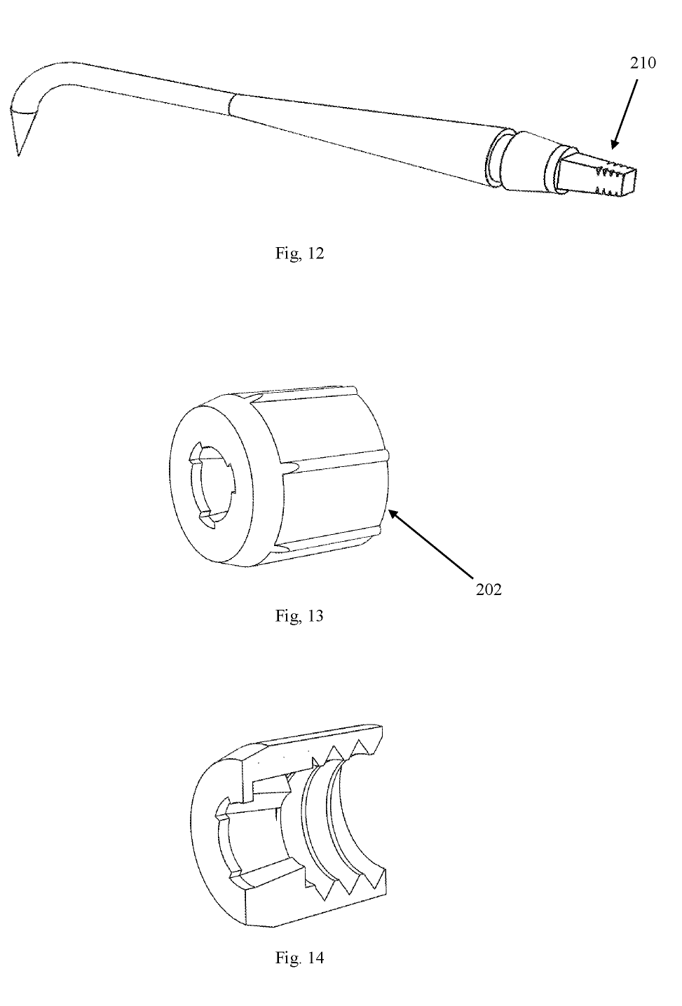

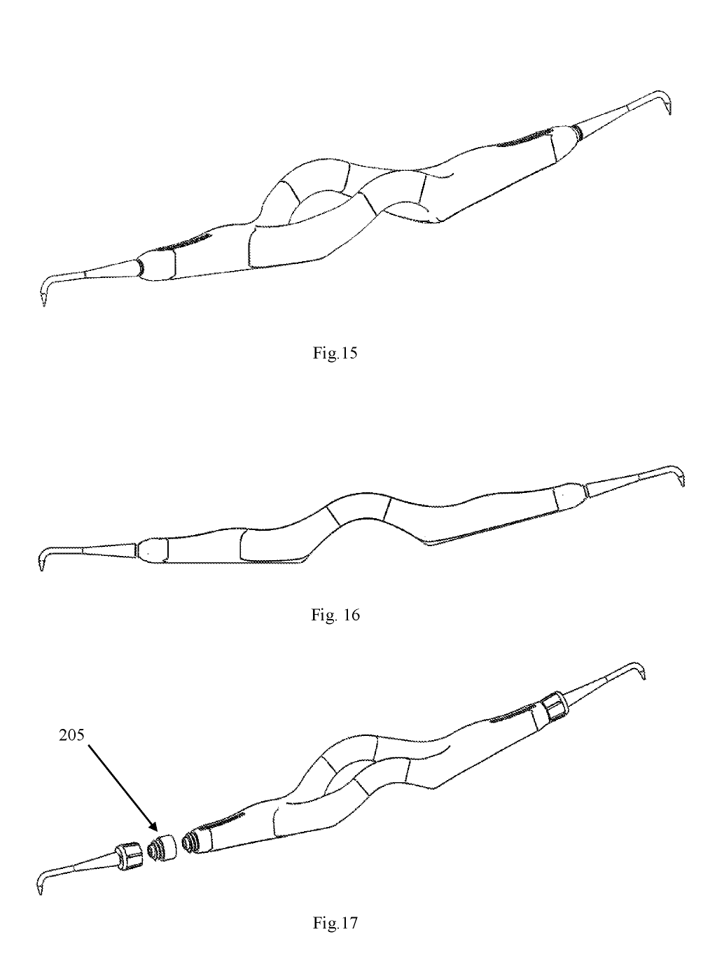

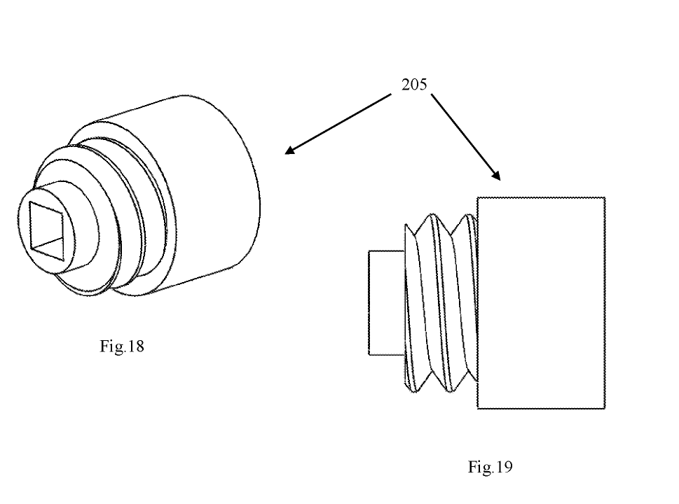

### DETAILED DESCRIPTION OF THE INVENTION

The Scaler assembly 100 will generally include a body with a central ring 101, a Scaler Tip Assembly 200 attached at each end of the Scaler Body 101. Each Tip Assembly 200 is comprised of a Scaler Tip 201 and an Attachment Collar 202. One or more Spacers 205 may be attached between the Scaler Tip Assembly 200 and the Scaler Body 101 to adjust the length of the Scaler Assembly 100.

The Scaler Body 101 will include an elongated arm extending from the central ring 102 in both the proximal and distal directions. The body will be comprised of a tubular configuration with a circular cross-section. However it is appreciated that various other configurations may be utilized for the body including square cross section, rectangular cross section or a cross section that is varying in shape to best suit a natural holding position. The body may be comprised of various materials including plastics, metals, metal alloys, and combination of plastics and metals which are autoclavable.

It is also appreciated that, in one of the embodiments, the Tips 201 will be integrally and permanently attached to the body 101, whereas in others, the Scaler Tips and Attachment Collars 201/202 respectively which form Tip Assemblies 200 are detachable from the body and are interchangeable. The Tip Assemblies 200 are in that case attached to the body by use of locking collars 202. The Scaler Tip 201 is rotatably attached to the Attachment Collar 202 and can rotate freely respective to each other. The

Scaler Tip Assembly 200 can be attached to the Scaler Body 101 by inserting the Scaler Tip 201 post into the receiving pocket in the Scaler Tip Body 101. The Attachment Collar 202 can be attached to the Scaler Body 101 by means of screw attachment, twist lock, snap on or other means well known in the art. The Scaler Tip Assembly 200 may be inserted at one or more predetermined radial positions. Scaler Tip 201 may be produced in many configurations of scaler tips known in the industry and utilize the rotatable collar attachment means as described and shown in the figures as well as other attachment means known in the art. Furthermore, in some embodiments, the overall length of the scaler assembly 100 can be adjusted by utilizing spacers 205 on one or both ends of the Scaler Body 101.

During Use, The user would insert the index finger through the central ring 102 of Scaler Body 101 placing the tip of the index finger in close proximity to the Scaler Tip Assembly 200. The middle finger and thumb can be placed on the sides of the elongated arms of the Scaler Body 101 allowing the user to reduce the pinching force on the device which will reduce prolonged and repetitive pinching stress and fatigue which can cause anatomical damage.

The Scaler Assembly 100 is designed for single handed use. The user may rotate the Scaler Assembly 100 around the index finger giving the user the ability to change from proximal to distal tip using one hand and without removing the index finger from the Scaler Assembly 100. The device is designed for both left handed and right handed use and can be adjusted to fit hands ranging from small in size to large.

1. A dental hand instrument system consisting of a handle having an elongated body with an opening to receive a finger through the elongated body and attachment means at each of the proximal and distal ends of the body for attachment of interchangeable tip assemblies.
Tip assemblies consisting of an attachment collar with attachment means to be fixedly attached to the proximal and distal ends of the elongated body and distal attachment means to be rotatably connected to the proximal end of the instrument tip
A spacer consisting of a proximal attachment means to be fixedly attached to the proximal and distal ends of the elongated body and a distal attachment means to be fixedly attached to the proximal end of the attachment collar

2. The dental Hand Instrument in claim 1, wherein the opening in the elongated body is centrally located

3. The Dental Hand Instrument in claim 1, wherein the opening in the elongated body is distally located

4. The Dental Hand Instrument in claim 1, wherein the elongated portion is shaped to support a finger

5. The Dental Hand Instrument in claim 1, wherein the elongated portion includes a textured surface

6. The Dental Hand Instrument in claim 1, wherein the finger receiving opening has a recess at the proximal end of each elongated portion to receive a finger

7. The Dental Hand Instrument in claim 1, wherein the device material can be steam sterilized

8. The Dental Hand Instrument body in claim 1, wherein the proximal and distal connection end fixedly attaches the Dental Instrument Tip assembly in at least one or more pre-determined radial positions

9. The Dental Instrument Tip assembly of claim 1, wherein the assembled Attachment Collar can rotate freely with respect to the instrument Tip

10. A dental hand instrument consisting of an elongated body with an opening to receive a finger and permanently attached scaler tips

11. The Dental Hand Instrument in claim 8, wherein the elongated portion is shaped to support a finger

12. The Dental Hand Instrument in claim 8, wherein the elongated portion includes a textured surface

13. The Dental Hand Instrument in claim 8, wherein the finger receiving opening has a recess at the proximal end of each elongated portion to receive a finger

14. The Dental Hand Instrument in claim 8, wherein the device material can be steam sterilized

15. The dental Hand Instrument in claim 8, wherein the opening in the elongated body is centrally located

16. The Dental Hand Instrument in claim 8, wherein the opening in the elongated body is distally located
